(19) United States
(12) Patent Application Publication
(10) Pub. No.: US 2023/0408663 A1
(43) Pub. Date: Dec. 21, 2023

(54) ULTRASONIC TRANSDUCER SYSTEM AND METHOD FOR MANUFACTURING THE SAME

(71) Applicant: Fraunhofer-Gesellschaft zur Foerderung der angewandten Forschung e.V., Munich (DE)

(72) Inventor: Jorge Mario MONSALVE GUARACAO, Dresden (DE)

(21) Appl. No.: 18/337,996

(22) Filed: Jun. 20, 2023

(30) Foreign Application Priority Data
Jun. 20, 2022 (DE) 102022206138.1

(51) Int. Cl. G01S 7/521; G01S 15/10; G01S 7/527

(52) U.S. Cl. CPC G01S 7/521; G01S 15/10; G01S 7/527

(57) ABSTRACT

An ultrasonic transducer system includes a transmission unit including a first natural frequency and configured to generate an ultrasonic signal. The ultrasonic transducer system includes a reception unit including a second natural frequency and configured to receive a response signal based on the ultrasonic signal. The second natural frequency is larger than the first natural frequency.

### CROSS-REFERENCE TO RELATED APPLICATION

This application claims priority from German Patent Application No. DE 10 2022 206 138.1, which was filed on Jun. 20, 2022, and is incorporated herein in its entirety by reference.

### BACKGROUND OF THE INVENTION

The present inventions relates to an ultrasonic transducer system and a method for manufacturing the same. In particular, the present invention relates to a broadband gas-coupled electrostatic ultrasonic transducer for the application of pulse compression methods as well as to micromachined ultrasonic transducers (MUT), in particular MUTs being directly coupled to a gas.

Ultrasonic distance measurement systems based on the time-of-flight of compression waves in a gas, i.e. not being submerged or in contact with a surface, have found many applications, including vehicle parking, approximation sensors for robots, wireless sensor networks for object tracing and gesture detection, or the like. In a general case, such time-of-flight measurements provide many applications, e.g. in the fields of radar and sonar. The problem solved is known as “time delay estimation,” wherein the delay between an emitted signal and a received signal is of interest, which is referred to as an active case, or wherein the delay between two received signals is of interest, which is referred to as a passive case.

Analogously to radar systems and sonar systems, gas-coupled ultrasound-based time-of-flight detectors may profit with respect to resolution and range if the measured pulse had a broadband characteristic, instead of working with a monochromatic wave.

The advantages of a broadband characteristic can be recognized more clearly with the properties of a so-called cross-correlation, a standard technique in radar and sonar. The cross-correlation corresponds to the integral across the time of the product between a signal and the time-delayed variation of another signal. If both signals differ only on the basis of the time delay, this operation would result in a maximum value for the delay that occurs, where these signals overlap the most, thus, it represents a maximum probable estimator of the time delay between both signals. The curve resulting from this operation provides an envelope whose maximum is at the delay to be detected and whose width is approximately reciprocally proportional to the bandwidth of the signal. This means that a long broadband pulse of constant amplitude is converted into a narrow peak centered around the time delay on the basis of the cross-correlation. Thus, objects close-by, whose echoes would normally render the received signal undetectable, can be detected with high precision with a detector. Furthermore, this operation is very robust against surrounding noise, wherein a high bandwidth also offers advantages in this regard, such as low static scattering of the estimation (Quazi, 1981) as well as low requirements with respect to the signal-noise ratio for a reliable detection (Weinstein & Weiss, 1984). This algorithm of the cross-correlation is actually only a variation of pulse compression methods, i.e. methods that convert a signal with a certain bandwidth and duration into a narrow peak. According to Klauder et al. (1960), the introduction of frequency-modulated signals in the field of radar has enabled the transmission of pulses comprising approximately a hundred times the energy of a monochromatic short pulse, which would need the same resolution and peak power.

A key parameter that determines the power of a pulse compression method is the dispersion factor, i.e. the product of the bandwidth and a period of the pulse, which should be significantly larger than 1 so that the system can really be considered as being broadband (Weinstein & Weiss, 1984). For small dispersion factors, the cross-correlation behaves as a quasi-periodic curve that oscillates with the center frequency and in which the side lobes fall of only slightly with respect to the maximum. In case of higher dispersion factors, a significant envelope occurs in the cross-correlation, facilitating the detection of the delay. This has led some researchers to the conclusion that the ratio between the bandwidth of the signal and its center frequency should be larger than 20% so that an ultrasonic transducer can be used as a broadband time-of-flight detector (Misra et al., 2013).

According to the above-mentioned criteria, most air-based distance measurement systems that belong to the conventional technology are narrowband converters. Standard implementations of piezoelectric micromachined ultrasonic transducers (PMUTs) and their capacitive counterparts (CMUTs) are of a narrowband nature due to their small friction losses and thus high Q factors when being coupled with air. The strategies to increase the bandwidth include the simultaneous operation of several resonators with different resonance frequencies, as described in U.S. Pat. No. 5,870,351, or the introduction of friction losses, in particular the damping by pressing-out thin air layers (Ma et al., 2019). A disadvantage of using an array of resonators is that the size of the device has to be increased with each additional transducer. Arrays with bandwidths of above 20% resulting therefrom are not known yet. The introduction of friction losses has proven to be effective to achieve higher bandwidths. Apte et al. (2014) reports on a CMUT whose relative bandwidth is 36%.

Outside of the area of micromachined transducers, the literature already reported on piezo-polymer films with a broadband characteristic. The system of Hazas and Hopper (2006) uses the high friction losses of a hemicyclic PVDF film so as to transmit and receive waves in the range 40-60 kHz, and the system of Fiorillo et al. (2020), inspired by a bat's cochlea, can operate in the range of 30-95 kHz due to its spiral shape. Recently, the strategy of a spiral-shaped transducer with several operation modes has also been implemented in the area of CMUTs, achieving a relative bandwidth or partial bandwidth of 12% (Adelegan, 2021). However, the spiral-shaped design needs to be adapted as to achieve higher relative bandwidths.

Thus, there is a need for an ultrasonic transducer system with a high relative bandwidth.

### SUMMARY

An embodiment may have an ultrasonic transducer system, comprising: a transmission unit comprising a first natural frequency and configured to generate an ultrasonic signal; a reception unit comprising a second natural frequency and configured to receive a response signal based on the ultrasonic signal; wherein the second natural frequency is larger than the first natural frequency.

Another embodiment may have a time-of-flight sensor with an ultrasonic transducer system according to the invention.

Another embodiment may have a method for manufacturing an ultrasonic transducer system, comprising: arranging a transmission unit comprising a first natural frequency so that the same is configured to generate an ultrasonic signal; arranging a reception unit comprising a second natural frequency so that the same is configured to receive a response signal based on the ultrasonic signal; so that the second natural frequency is larger than the first natural frequency.

A core idea of the present invention is to obtain a broadband ultrasonic transducer system through the fact that natural frequencies (or eigenfrequencies) of a transmission unit (or transmission means) on the one hand and of a reception unit (or reception means) on the other hand differ from each other and that the natural frequency of the reception unit is larger than the natural frequency of the transmission unit. Through the distances of the natural frequencies, the ultrasonic transducer system becomes broadband in nature, and an ultrasonic transducer system appropriate for pulse compression methods can also be provided in a simple way.

According to an embodiment, an ultrasonic transducer system includes a transmission unit comprising a first natural frequency and configured to generate an ultrasonic signal. The ultrasonic transducer system includes a reception unit comprising a second natural frequency and configured to receive a response signal based on the ultrasonic signal. The second natural frequency is larger than the first natural frequency.

According to an embodiment, the transmission unit and the reception unit form a bandpass that is at least partially characterized by the first natural frequency and the second natural frequency. Through this, the operation bandwidth of the ultrasonic transducer system can be adjusted effectively.

According to an embodiment, the transmission unit functions as a high-pass filter and the reception unit functions as a low-pass filter for the bandpass.

According to an embodiment, the second natural frequency is larger than the first natural frequency as least by a factor of 1.1, which enables a high relative bandwidth.

According to an embodiment, the transmission unit and/or the reception unit includes a sound transducer including at least one of a capacitive micromachined sound transducer, a piezoelectric micromachined sound transducer, and a polyvinylidene fluoride film. These elements are well suited for an ultrasonic transducer system according to the invention.

According to an embodiment, the ultrasonic transducer system includes a driver unit (or driver means) coupled to the transmission unit and configured to apply to a transmission ultrasonic transducer of the transmission unit an electric voltage that is proportional to a received excitation signal. This enables precise control of the transmission unit.

According to an embodiment, the transmission ultrasonic transducer is a capacitive transmission ultrasonic transducer and the driver unit is configured to apply an electrical bias voltage to the capacitive transmission ultrasonic transducer, and to apply the excitation signal with respect to the electrical bias voltage. This enables an energy-efficient operation of the transmission ultrasonic transducer.

According to an embodiment, the ultrasonic transducer system includes an evaluation unit (or evaluation means) configured to evaluate the response signal on the basis of a pulse compression method. The application of a pulse compression method enables a precise detection of objects with the ultrasonic transducer system.

According to an embodiment, the ultrasonic transducer system is configured for an operation of the transmission unit in a single transmission oscillation mode and/or for an operation of the reception unit in a single reception oscillation mode. This advantageously enables the use of sound transducers of the same type and therefore a simple operation and/or lower complexity.

According to an embodiment, to this end, the transmission unit is configured such that a plurality of sound transducers comprising matching natural frequencies within a tolerance range is provided. Alternatively or additionally, the reception unit is configured such that a plurality of sound transducers comprising matching natural frequencies within a tolerance range is provided so that matching excitation signals, or evaluation signals, can be applied, or obtained, which enables simple signal processing.

According to an embodiment, the transmission unit is configured to emit the transmission signal with a characteristic so as to obtain an amplitude of the reception signal at the location of the reception unit, comprising a local maximum within a tolerance range. By orientating the transmission unit and the reception unit relative to each other, a high signal quality may be obtained with the reception unit, which enables a precise signal evaluation.

According to an embodiment, the characteristic of the transmission signal is based on at least one of a radiation property of the transmission unit, a characteristic of a fluidic opening of a substrate of the transmission unit, e.g. for providing a direction, and an antenna structure for shaping the transmission signal, e.g. horn antennas or the like. This enables tuning and adapting the ultrasonic transducer system with respect to a respective field of use.

According to an embodiment, the ultrasonic transducer system includes an evaluation unit configured to evaluate the response signal on the basis of a measurement of a quantity based on an electrical charge of a reception ultrasonic transducer of the reception unit, and further includes an amplifier unit (or amplifier means) coupled to a reception ultrasonic transducer of the reception unit and configured to generate a transducer signal received by the reception ultrasonic transducer, said transducer signal being approximately directionally proportional to a charge at the reception ultrasonic transducer. The proportionality relationship is advantageous for the evaluation, in particular when using pulse compression methods.

According to an embodiment, the reception ultrasonic transducer is a capacitive reception ultrasonic transducer, and the amplifier unit is configured to apply an electrical bias voltage to the capacitive reception ultrasonic transducer. This enables a high quality of a signal evaluation around the bias voltage.

According to an embodiment, this transmission unit comprises a horn antenna structure configured to influence a radiation direction of the ultrasonic signal. This may enable an efficient and exact adjustment of a characteristic of the transmission signal.

According to an embodiment, the reception unit comprises a horn antenna structure configured to influence a directional characteristic of the reception unit for receiving the response signal. Among other things, this enables the reduction of disturbing sounds or noise.

According to an embodiment, the transmission unit is configured to output the ultrasonic signal into a gaseous medium, and/or the reception unit is configured to receive the response signal from a gaseous medium. This enables a high number of possible fields of application.

According to an embodiment, the system comprises a relative bandwidth of the transmission unit and the reception unit of at least 15%, preferably at least 17%, and particularly preferably at least 20%. A high partial bandwidth is advantageous for different applications.

According to an embodiment, an ultrasonic transducer of the transmission unit and an ultrasonic transducer of the reception unit are arranged on a substrate and are connected to a mutual medium via openings in the substrate. This enables the precise orientation and positioning of the ultrasonic transducers relative to each other.

According to an embodiment, the substrate includes a printed circuit board (PCB). This enables simultaneous contacting of the corresponding elements.

According to an embodiment, a structure of the transmission unit comprises a Q factor of up to 3.5 and/or a structure of the reception unit comprises a Q factor of up to 3.5. In an advantageous interaction with the different natural frequencies, this enables a broadband operation of the ultrasonic transducer system.

According to an embodiment, a transmission ultrasonic transducer of the transmission unit is arranged in a volume, wherein the volume prevents an acoustic short circuit for the transmission ultrasonic transducer. Alternatively or additionally, a reception ultrasonic transducer of the reception unit is arranged in a volume preventing an acoustic short circuit for the reception ultrasonic transducer. Through this, a precise result may be obtained with smaller volumes of the medium being moved.

According to an embodiment, a transmission ultrasonic transducer of the transmission unit and a reception ultrasonic transducer of the reception unit are arranged at different substrates. Besides individual manufacturing of the transmission unit and the reception unit, this enables degrees of freedom in the relative positioning with respect to each other.

According to an embodiment, the transmission ultrasonic transducer is arranged in a first volume for preventing an acoustic short circuit and the reception ultrasonic transducer is arranged in a different second volume for preventing an acoustic short circuit. This enables an individual operation free of interference.

According to an embodiment, a method for manufacturing an ultrasonic transducer includes arranging a transmission unit comprising a first natural frequency so that the same is configured to generate an ultrasonic signal. The method includes arranging a reception unit comprising a second natural frequency so that the same is configured to receive a response signal based on the ultrasonic signal. The method is carried out so that the second natural frequency is larger than the first natural frequency.

According to an embodiment, such a method includes configuring the ultrasonic transducer in which a Q factor of the ultrasonic transducer system is selected on the basis of the first natural frequency and the second natural frequency such that, on the one hand, a desired relative bandwidth of the system is achieved by selecting a low Q factor, and such that, on the other hand, a high Q factor is obtained for obtaining a sensitivity for the overall transmission function. This enables a precise adjustment of the inventive concept with respect to the corresponding field of views. Further advantageous implementations of the present invention are defined in the claims.

### BRIEF DESCRIPTION OF THE DRAWINGS

Embodiments of the present invention will be detailed subsequently referring to the appended drawings, in which:

FIG. 1 shows a schematic block circuit diagram of an ultrasonic transducer system according to an embodiment;

FIG. 2 shows an exemplary diagram for illustrating a schematic overall transmission function of an ultrasonic transducer system according to an embodiment;

FIG. 3 shows a schematic block circuit diagram of a further ultrasonic transducer system according to an embodiment;

FIG. 4 shows a schematic side-sectional view of an ultrasonic transducer system according to an embodiment, comprising horn antenna structures;

FIG. 5 shows a schematic graph having plotted at the abscissa the relative distance between the natural frequencies and having plotted at the ordinate the Q factor so as to explain embodiments described herein;

FIG. 6 shows an exemplary graph having illustrated at the abscissa the Q factor and having illustrated at the ordinate the absolute value of the overall transfer function of an ultrasonic transducer system so as to explain embodiments described herein;

FIG. 7 shows a schematic flow diagram of a method according to an embodiment.

### DETAILED DESCRIPTION OF THE INVENTION

Before embodiments of the present invention are subsequently described in detail on the basis of the drawings, it is to be noted that elements, objects, and/or structures that are identical, functionally identical, or identical in effect are denoted in the different drawings with the same reference numerals so that the description of these elements illustrated in different embodiments is interchangeable or can be applied to each other.

Subsequently described embodiments are described in connection with a multitude of details. However, embodiments can also be implemented without these detailed features. In addition, for the sake of comprehensibility, embodiments are described using block circuit diagrams as a replacement for a detailed illustration. Furthermore, details and/or features of individual embodiments may be readily combined, as long as the contrary is not explicitly mentioned.

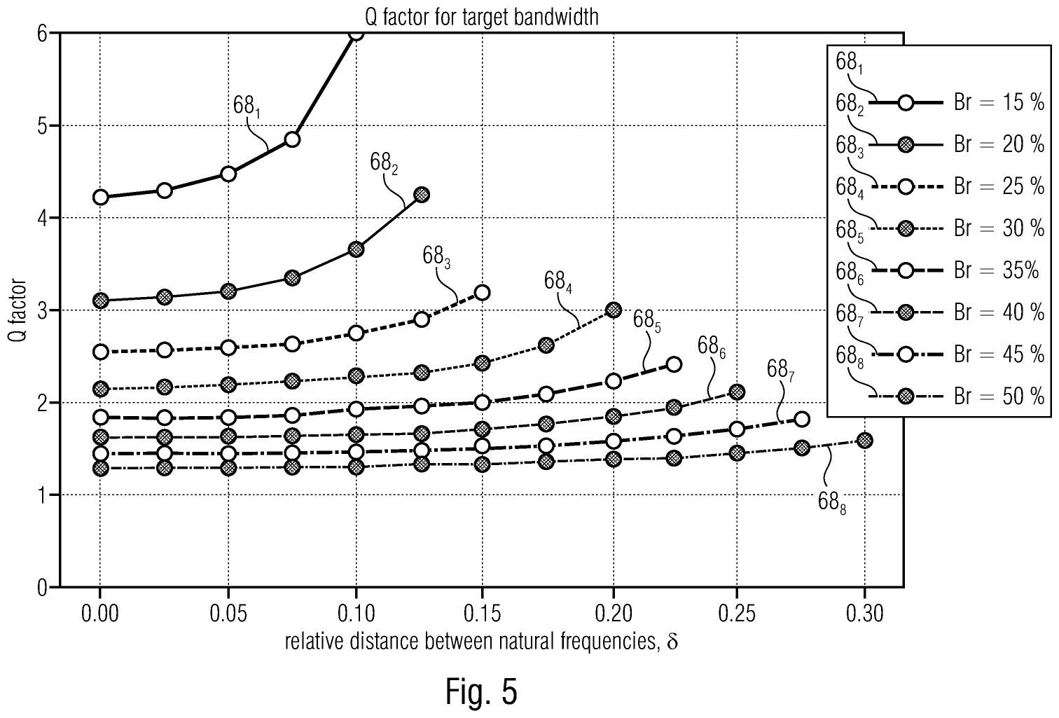

Embodiments of the present invention relate to the use of a transmission unit and a reception unit as two units that are mutually operated in the ultrasonic transducer system. This achieves a higher flexibility for achieving high relative bandwidths or partial bandwidths, since the transducer system is decoupled into independent transmission and reception units. In contrast, known time-of-flight sensors are based on a switching method in which the same unit is first operated as a transmitter and subsequently switched into a reception mode. In such concepts, the total bandwidth results from the multiplication of the transfer function with itself, which in turn limits the frequency range. On the other hand, the approach according to the invention consists of independent transmission and reception units, wherein, in some implementations, the transmission unit may function as a high-pass filter and the reception unit may function as a low-pass filter. At the lower end, the bandwidth of the entire frequency response may be determined by the resonance frequency or natural frequency of the transmission unit, and at the upper end, by the resonance frequency or natural frequency of the reception unit, or may at least be based thereon. By appropriately designing the transmission unit and the reception unit, such a bandwidth may be adjusted or implemented arbitrarily at least within a large range, as long as the radiation characteristic in the desired transmission angle remains relatively constant at the selected frequencies. In this case, it can be considered that the transmission unit and the reception unit are each not operated in a strongly underdamped state, since the total response would then possibly comprise two separate maximums or peaks, which may also be considered such that, in such a case, the ultrasonic waves are emitted in a range in which they are not received or only inadequately received, or vice versa. This is avoided in the embodiments described herein. With respect to FIG. 5, a strongly underdamped state may be understood as simultaneously using a distance of the natural frequencies that is not too big and a Q factor of up to 4, preferably up to 3.6, particularly preferably 3.5 or less, wherein the requirements with respect to a lower Q factor are increased with an increasing distance of the natural frequencies, which is described in more detail in connection with FIG. 5.

Thus, embodiments also relate to time-of-flight sensors or run-time sensors with a structure described herein or an ultrasonic transducer system described herein.

Some of the embodiments described herein refer to a Q factor of a transmission unit, a reception unit, or the transfer system. The Q factor may relate to a linearized frequency response of the “driver-transmitter” system or “receiver-amplifier” system. Both parts do not necessarily have to comprise the same Q factor, however, it may facilitate modeling.

The “quality factor” (Q factor) is a quantity for the damping of a mechanical oscillator. In a classical harmonic oscillator, this variable is defined as follows:

$$\frac{k}{{ω}_{n}^{2}} \ddot{x} + \frac{k}{{ω}_{n} Q} \dot{x} + kx ( t ) = F ( t )$$

wherein “ωₙ” is the natural frequency and “k” is the stiffness constant of the oscillator. The roll of the Q factor becomes clearer when illustrating the transfer function of the oscillator in the frequency domain:

$$\frac{X ( ω )}{F ( ω )} = \frac{1}{k} ( \frac{1}{( {ω}^{2} - {ω}_{n}^{2} ) + \frac{j {ωω}_{n}}{Q}} )$$

$$\vert X ( ω ) \vert ∼ \frac{1}{\sqrt{{( {ω}^{2} - {ω}_{n}^{2} )}^{2} + {( \frac{{ωω}_{n}}{Q} )}^{2}}}$$

At high Q factors (Q>>1), a significant narrow peak is created in the frequency response in the proximity of the resonance frequency. At Q factors near 1, a maximum of the frequency response can be found at ωₙ, however, this peak is no longer narrow, but has a certain width. At very low Q factors (Q<<1), there is no longer a peak in the proximity of the resonance frequency, but the system behaves like a low-pass filter.

From a physical point of view, all friction losses contribute to the overall Q factor, either due to the interaction with a fluid, due to energy losses in the solid body, or for other reasons. In gas-coupled micromachined ultrasonic transducers, the friction with the gas has a dominant role when determining the Q factor. Since gases are a lot less viscous than liquids, CMUTs and PMUTs show much higher Q factors compared to the case of submersion, and they therefore behave in a narrowband manner.

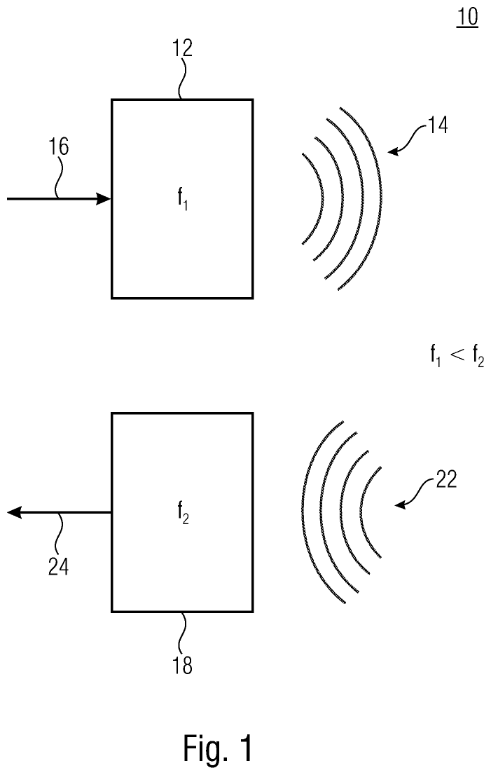

FIG. 1 shows a schematic block circuit diagram of an ultrasonic transducer system 10 according to an embodiment. The ultrasonic transducer system 10 includes a transmission unit 12 that may comprise one or several ultrasonic transducers and that comprises a first natural frequency f₁ and that is configured to generate an ultrasonic signal 14, e.g. on the basis of a control signal 16 obtained from a control unit (or control means) or driver unit.

The ultrasonic transducer system 10 includes a reception unit 18 that may comprise one or several ultrasonic transducers and that comprises a second natural frequency f₂. The reception unit 18 is configured to receive a response signal 22 based on the ultrasonic signal 14. The response signal 22 may be converted by the reception unit 18 into a signal 24 that comprises information about the response signal 22, e.g. by reading-out and/or processing a reaction of an ultrasonic transducer of the reception unit 18. The natural frequency f₂ of the reception unit 18 is here larger than the natural frequency f₁ of the transmission unit 12.

Each taken for itself, the transmission unit 12 and/or the reception unit 18 may comprise one or several ultrasonic transducers. For example, each of these ultrasonic transducers may be formed as a capacitive micromachined sound transducer (CMUT) a piezoelectric micromachined sound transducer (PMUT) or as a polyvinylidene fluoride film (PVDF)-based transducer. In a preferred embodiment, the transmission unit and the reception unit are configured such that they comprise only a single oscillation mode or are designed for such an oscillation mode, i.e. only one relevant operation resonance frequency or natural frequency is setup at least in the operation spectrum. This may be done by using a single correspondingly designed sound transducer in the transmission unit and/or the reception unit. If the transmission unit 12 and/or the reception unit 18 has a higher number of ultrasonic transducers, they may have matching natural frequencies within a tolerance range of 5%, 2% or 1% or even less, which may also be understood such that there are only manufacturing-related deviations or tolerances, but that the ultrasonic transducers have otherwise matching natural frequencies. In other words, the transmission unit 12 or the reception unit 18 may comprise transducers that approximately comprise the same oscillation mode, i.e. the natural frequencies of the transducers hardly differ. This may achieve that the transmission unit or the reception unit can still be operated in a matching way in the case of several transducers.

The natural frequency may relate to a resonance frequency of the structure of the ultrasonic transducers that are used. The term “natural frequency” is used in the embodiments described herein because some embodiments comprise a Q factor that is smaller than 1, which hardly causes a resonance oscillation in a mechanical response of the respective structure, however, the natural frequency is still a property of the system.

Here, the deviation between the natural frequencies f₁ and f₂ is not to be understood such that they are manufacturing-related or undesired deviations. Rather, these deviations are consciously caused and may be designed such that the second natural frequency is larger than the first natural frequency at least by a factor of 1.1, 1.2, 1.3, or more.

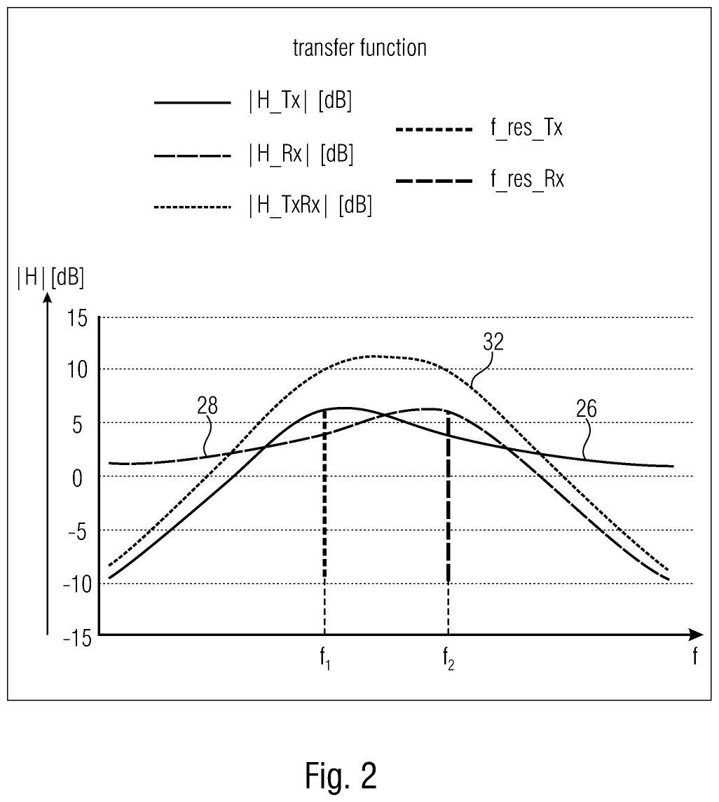

FIG. 2 shows an exemplarily graph 20 having plotted at its abscissa the frequency f and at its ordinate the absolute value of a transfer function H, wherein the illustration shows several transfer functions. The graph shows the different natural frequencies f₁ and f₂, of which the natural frequency f₂ is larger than the natural frequency f₁. The numerical values at the ordinate are only exemplary and are construed for a mutual comparison and, in embodiments of the present invention, may readily deviate from the illustrated values without limitation of the inventive idea.

A curve 26 exemplarily illustrates a possible course of an absolute value of the transfer function H_{Tx} of the transmission unit 12 across the frequency axis and possibly comprises a maximum at the natural frequency f₁. A curve 28 shows an exemplary possible course of an absolute value of a transfer function H_{Rx} of the reception unit 18 that may comprise a maximum at the natural frequency f₂. According to embodiments, the transmission unit 12 is designed as a high-pass filter and the reception unit 18 is designed as a low-pass filter so as to mutually enable a bandpass behavior of the transfer function H_{TxRx}, which is exemplarily illustrated in the curve 32 as an absolute value.

This means that the transmission unit and the reception unit may form a bandpass that is at least partially characterized by the natural frequencies f₁ and f₂, where the transmission unit contributes as a high-pass filter and the reception unit contributes as a low-pass filter.

In other words, FIG. 2 shows the functional principle of a broadband ultrasonic transducer described herein. The frequency response function of the transmitter (H_{Tx}) corresponds to a high-pass filter, the frequency response function of the receiver (H_{Rx}) corresponds to a low-pass filter. The combination of the two transfer functions results in a bandpass filter. The bandwidth of this filter may directly depend on the distance between the resonance frequencies or natural frequencies of the transmitter and the receiver. For this filter to be a real bandpass system, embodiments provide that the corresponding oscillators do not behave like a resonator amongst each other; otherwise, the resulting function consists of two peak values that are spaced apart from each other. The high-pass behavior of the transmitter unit may correspond to the typical frequency response of a direct radiator loudspeaker. The low-pass behavior of the receiver unit may be created by measuring the electrical charge at the transducer.

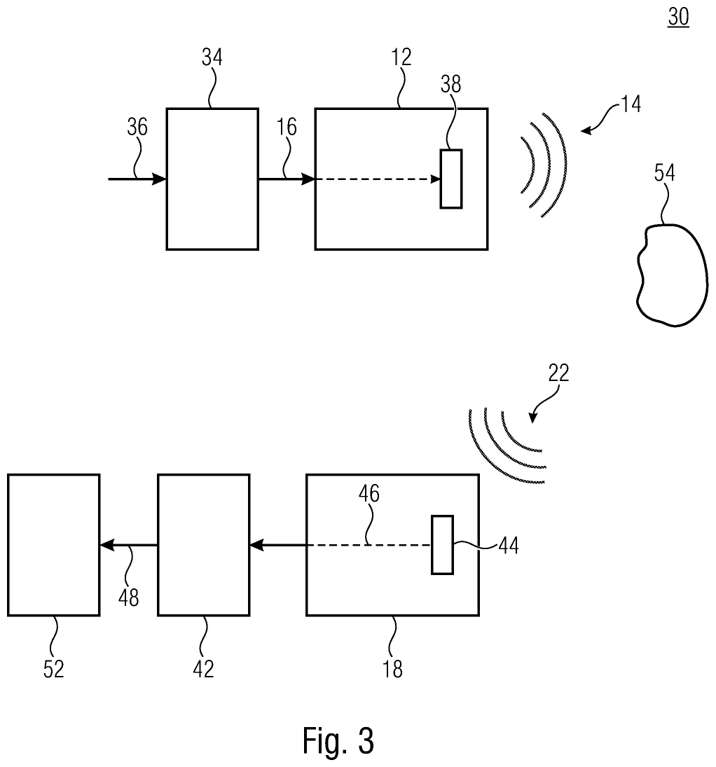

FIG. 3 shows a schematic block circuit diagram of an ultrasonic transducer system 30 according to an embodiment. The ultrasonic transducer system 30 includes the transmission unit 12 and the reception unit 18 according to the discussions regarding the ultrasonic transducer system 10. The transmission unit 12 may be configured to output the ultrasonic signal 14 into a gaseous medium. Alternatively or additionally, the reception unit 18 may be configured to receive the response signal 22 from a gaseous medium.

The ultrasonic transducer system 34 includes a driver unit 34 coupled to the transmission unit 12 and configured to apply, e.g. via the control signal 16, to a transmission ultrasonic transducer 38 an electrical voltage that is proportional to a received excitation signal 36. For example, the transmission ultrasonic transducer 38 may be or include a capacitive transmission ultrasonic transducer. In such an implementation, it is advantageous to configure the driver unit 34 such that it applies an electrical bias voltage to the capacitive transmission ultrasonic transducer and to apply the electrical voltage with respect to the electrical bias voltage. This enables a high sensitivity of the capacitive transmission ultrasonic transducer with respect to variations in the control.

The ultrasonic transducer system 30 may comprise an amplifier unit 42 coupled to a reception ultrasonic transducer 44 configured to receive the response signal 22. The amplifier unit 42 may be configured to receive a transducer signal 34 received by the reception ultrasonic transducer 44, e.g. as a signal 24 or a pre-stage thereof. The amplifier unit 42 may be configured to generate, on the basis of the transducer signal 46, an amplified signal 48 that is approximately directly proportional to a charge at the reception ultrasonic transducer 44. Alternatively or additionally, the ultrasonic transducer system 30 may comprise an evaluation unit 52 configured to evaluate the response signal 22 on the basis of the amplified signal 48 and the electrical charge of the reception ultrasonic transducer 44 or a quantity derived therefrom.

If, for example, the reception ultrasonic transducer 44 is a capacitive reception ultrasonic transducer, the amplifier unit 42 may be advantageously configured to apply an electrical bias voltage to the ultrasonic transducer 44 so as to enable a precise evaluation.

By transducing and evaluating the response signal 22, properties such as size, position, speed, or quality of an object 54 may be inferred. The evaluation unit 52 may be configured to evaluate the response signal 22 on the basis of a pulse compression method. Such a pulse compression method may compare two mutually delayed signals and generate in the result a peak or increase centered around the time delay between both signals. Depending on the duration of the pulses and their bandwidth, a sharper or broader peak may be generated. An example of such a pulse compression method is the cross-correlation between signals 14 and 22. Methods on the basis of the chirp RADAR may also be used. For the case of gas-carried ultrasound, i.e. a transfer of the signals 14 and/or 22 through a gaseous medium such as air, hydrogen, natural gas and/or others, relative bandwidths of the ultrasonic transducer system of more than 20% may be achieved.

The elements of the driver unit 34, the amplifier unit 42, and the evaluation unit 52 described in connection with the ultrasonic transducer system may be employed individually or in groups and may be employed in the ultrasonic transducer system 10 in the respective implementation as well.

Embodiments provide a device for generating ultrasound and capturing ultrasound in a gaseous medium such as air. In this case, the device possibly comprises separated transmission and reception units. The partial bandwidth, or relative bandwidth, of the device may be set to values above 20% through construction. Such a device is therefore suited for the implementation of pulse compression methods that are already used in sonar systems and radar systems and that provide a higher resolution range and capturing range than narrow band techniques. In contrast to the known solution approaches, embodiments do not require an arrangement of resonators with several oscillation modes. In embodiments, it is sufficient to use only one oscillation mode for the transmission unit 12 and a further oscillation mode for the reception unit 18. A relevant aspect of embodiments described herein is the fact that the implemented oscillators do not operate in a strongly underdamped state. Embodiments also relate to keeping the radiation characteristic in the selected medium relatively constant, at least within the desired transfer direction and in the desired frequency range.

In this case, embodiments related to the behavior of the transmission unit 12 and the high-pass filter and the behavior of the receiver unit 18 as a low-pass filter. The following describes how such a behavior can be realized in gas-coupled micromachined ultrasonic transducers (MUTs). The high-pass behavior of gas-coupled electroacoustic transducers may correspond to the typical frequency response of a direct radiator loudspeaker. This may be described on the basis of the analogy of a rigid piston enclosed in an acoustic baffle. The amplitude of the pressure waves generated through this is directly proportional to the acceleration of the piston and is inversely proportional to the distance that the wave has travelled. The acceleration of a classical spring-mass-damper system operated with a force of a constant amplitude may represent a high-pass behavior. At lower frequencies, the acceleration increases with the frequency until the resonance is reached. Above the resonance, the oscillation is possibly determined mainly by the inertness, the acceleration may therefore remain relatively constant with the frequency. In resonance, there is a movement amplification that may strongly depend on the damping (measured with the so-called Q factor). However, for Q factors below 1, there is no amplification in the natural frequency. Such a high-pass behavior of an air-coupled micromachined ultrasonic transducer is experimentally described in Monsalve et al. (2020) and Hazas and Hopper (2006).

The low-pass behavior of an ultrasonic receiver may be achieved by measuring the electrical charge. Regardless of whether the micromachined ultrasonic transducer comprises a capacitive or piezoelectric functionality, it has a capacity change if it is excited by a pressure wave. In this case, the analogy of a spring-mass system also helps to see this behavior. In a mechanical oscillator operated by a force of a constant amplitude the position behaves like a low-pass filter, it remains relatively constant for frequencies below the resonance and decreases strongly after the resonance frequency. This fictional position of the oscillator may be understood as a movement of the membrane or the deformable gas-coupled element. In capacitive and piezoelectric transducers, this movement may be causally coupled with the electrical charge, even in an approximately linear relationship. The PVDF-based transducers may be understood as piezoelectric transducers with high damping.

In embodiments, corresponding electronic components are provided at the transmission unit 12 and the receiver unit 18, for the transfer of signals, said components being contacted therewith. In the case of the transmission unit, the driver unit 34 may be coupled, wherein the same is configured to apply to the transducer an electrical voltage 16 that is proportional to the signal 36. For a capacitive transmitter, to this end, a bias voltage may be applied, e.g., which may be provided by the driver unit 34. In the case of the receiver unit 18, the amplifier unit 42 may be coupled, wherein the same may generate a voltage that is approximately directly proportional to the charge at the transducer 44. For a capacitive transducer 44, a bias voltage may be preferably provided by the amplifier unit 42. Embodiments of charge amplifiers are known.

The entire behavior of the transfer of the ultrasonic pulse 14 may be seen as a combination of three processes:
1. The transmitter converts a signal into the ultrasonic signal 14;
2. the medium transfers the signal; and
3. the receiver converts the received ultrasound into a second signal.

These steps may be modeled as the multiplication of three transfer functions, according to which:

Hₜₒₜₐₗ(ω)=H_{Tx}(ω)H_{Rx}(ω)H_{Rx}(ω).

This results in the fact that the frequency behavior of the medium is to be considered in the relevant frequency range, as well including the radiation characteristic. This radiation characteristic may depend on measurements/dimensions of the component and its housing, which may in turn be put in relation to the wavelength.

A possible solution through which the directional characteristic could experience a slight frequency variation is that the ultrasonic transducer may act like a point source or like a piston surrounded by an acoustic baffle. This may be considered on the basis of the design of the housing and with the selection of the dimensions of the ultrasonic transducer.

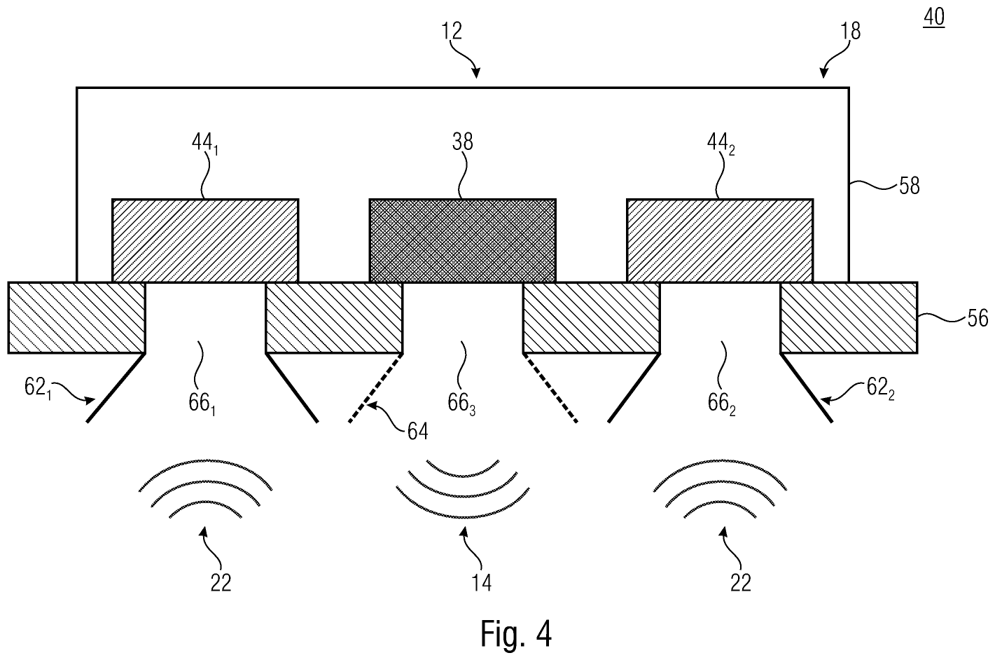

FIG. 4 shows a schematic side-sectional view of an ultrasonic transducer system 40 according to an embodiment, for describing additional modifications that could readily be implemented in the ultrasonic transducer systems 10 and/or 30 as well. For example, the transmission unit 12 includes the transmission ultrasonic transducer 38, wherein a greater number of transmission ultrasonic transducers may be readily arranged. The reception unit 18 may comprise two or more reception ultrasonic transducers 44₁ and 44₂. For example, they may be arranged symmetrically around the transmission ultrasonic transducer 38 or may be mounted on the basis of other design criteria in a previously specified arrangement.

Ultrasonic transducers 38 of the transmitter unit 12 and ultrasonic transducers 44₁ and 44₂ of the reception unit 18 may be arranged on the same or separate substrates and may be connected via openings in the substrate 56 with a mutual, e.g. gaseous, medium. For example, the substrate 56 includes a printed circuit board.

In an embodiment, the ultrasonic transducers 38, 44₁ and 44₂ are arranged on a mutual substrate 56, which may include a printed circuit board (PCB) or another carrier structure, which also does not exclude semiconductor-based materials. For at least partially adjusting a directional characteristic and/or for avoiding acoustic short circuits, the sound transducers 38, 44₁ and 44₂ may be arranged within a housing 58 that may include any material, such as a plastic material, a metal material, or a semiconductor material, or any other material, and that is enclosed by the substrate 56 at least at one remaining side. Although the sound transducers 38, 44₁ and 44₂ are illustrated such that they are arranged on the mutual substrate 56 and arranged within the same housing 58, alternatively, separate substrates may be provided for the transmission unit 12 and the reception unit 18, and/or separate housings may be provided, e.g. to provide separate volumes in which the respective sound transducers 38 on the one hand and 44₁ and 44₂ on the other hand are arranged.

According to embodiments, the transmission ultrasonic transducer 38 is arranged in a volume, e.g. the housing 58, to prevent an acoustic short circuit for the transmission ultrasonic transducer. Alternatively or additionally, ultrasonic transducers of the reception unit may be arranged in the volume to prevent an acoustic short circuit for the reception ultrasonic transducers 44₁ and 44₂.

The transmission unit 12 may comprise a horn antenna structure 64 configured to influence a radiation direction of the ultrasonic signal 14. Alternatively or additionally, the reception unit may comprise a horn antenna structure 66₁ and/or 66₂ configured to influence a directional characteristic of the reception unit for receiving the response signal 22.

Antenna structures 62₁ and 62₂ for the reception unit 18 and/or an antenna structure 64 for the transmission unit 12 may be arranged at openings 66₁, 66₂ and 66₃ of the substrate 56 so as to fully or partially adjust a directional characteristic for the transmission signal 14 and/or the response signal 22. The characteristic of the transmission signal 14 may be based on a radiation property of the transmission unit 12, such as a shape or implementation or relative positioning or the like, on a characteristic of a fluidic opening 66₃ of the substrate 56, and/or on the antenna structure 64 for shaping the transmission signal 14. For example, the antenna structure 62 and/or 64 may have the shape of a funnel or a horn antenna and may comprise a different geometry setup for shaping the ultrasonic signals 14 and/or 22.

Alternatively or additionally, antenna structures 62₁ and 62₂ and/or corresponding implementations of the opening 66₁ and 66₂ may be adjusted so as to adjust a reception characteristic for the receiver unit 18. By adapting the transmission unit 12 and/or the receiver unit 18, the transmission unit 12 may emit the transmission signal 14 with a characteristic so as to obtain an amplitude of the reception signal 22 at the location of the reception unit 18, comprising a local maximum within a tolerance range. In other words, the transmission unit 12 and the receiver unit 18 may be tuned to each other, and shaping may be possibly carried out by the antennas 62 and 64, such that a usable reception signal 18 is received for the frequency range applied and within the volume to be monitored.

In other words, FIG. 4 shows a possible implementation of a system according to the invention. The transmission unit 38 emits a broadband ultrasonic impulse 14 that is reflected at an object in the surrounding area and that reaches the reception units 44₁ and 44₂ with a certain delay. The housing for these elements may consist of a printed circuit board 56 with corresponding gas openings 62₁, 62₂ and 66₃ and may provide a cavity that may ensure acoustic and electric insulation. At the backside of the printed circuit board, an acoustic coupling, e.g. one of several horns 62₁, 62₂ and/or 64, may be attached, e.g. to influence the directional characteristic of the components.

In still other words, a further possibility for designing the directional characteristic is the use of horns. If the medium does not change the amplitude of the transmitting pressure wave in a significant frequency-depending manner, the frequency response of the time-of-flight sensor based on the ultrasonic transducer system may be derived from the multiplication of the transfer functions of the transmitter and the receiver. The mathematical expressions of classical second order systems are known. Here, a dimensionless notation clearly describing the effect of embodiments described herein is introduced. ω₁ is the natural frequency of the transmitter and ω₂ is the natural frequency of the receiver, wherein

σ=ω₂−ω₁>0.

Here, the notations ω₂ and ω₁ may represent the angular frequency representation of the natural frequencies f₁ and f₂.

With respect to the mean value ω_{c} with ω_{c}=(ω₁+ω₂)/2, a normalization may be implemented as follows:

$$δ = \frac{σ}{{ω}_{c}} ,$$

$${Ω}_{1} = \frac{{ω}_{1}}{{ω}_{c}} = 1 - \frac{δ}{2} ,$$

$${Ω}_{2} = \frac{{ω}_{2}}{{ω}_{c}} = 1 + \frac{δ}{2}$$

Thus, the multiplication of the transmitter transfer function and the receiver transfer may be expressed as follows:

$$\vert {H}_{TxRx} ( Ω ) \vert = \frac{{Ω}^{2}}{\sqrt{{( {( 1 - \frac{δ}{2} )}^{2} - {Ω}^{2} )}^{2} + {( ( 1 - \frac{δ}{2} ) \frac{Ω}{Q} )}^{2}}} \frac{{( 1 + \frac{δ}{2} )}^{2}}{\sqrt{{( {( 1 + \frac{δ}{2} )}^{2} - {Ω}^{2} )}^{2} + {( ( 1 + \frac{δ}{2} ) \frac{Ω}{Q} )}^{2}}}$$

For reasons of clarity, a proportionality constant is not illustrated, since it can be ignored in the analysis regarding the bandwidth. In FIG. 2, this mathematical function is illustrated as a graph.

In the design of a system according to the invention, the relative distance between the natural frequencies (δ) and the amount of damping (Q) may be adjusted. To describe the principle according to the invention, the same Q factor for the transmitter unit and the receiver unit is sometimes assumed, however, which is not required. With the dimensions of the oscillating deformable element, e.g. a membrane, preferably of a deflectable micro-beam damped on one side or on two sides, the natural frequency of the transmitter and the receiver may usually be adjusted very precisely. The adjustment of the Q factor may be achieved in gas-coupled ultrasonic transducers mainly with an acoustic design, since the friction losses from other sources are usually much smaller. Since the gases are much less viscous than liquids, micromachined ultrasonic transducers may have much higher Q factors compared to the case of submersion, e.g. in a liquid or the like, and may therefore behave in a very narrowband way.

For example, if the design only relates to the suppression of the Q factor and a known concept in which the same transducer is switched between a transmission mode and a reception mode is considered, the case of δ=0 is obtained in the above equation. In contrast, embodiments are configured such that δ>0. According to an embodiment, a structure of a transmission unit 12 comprises a Q factor of up to 3.5 and/or a structure of the reception unit 18 comprises a Q factor of up to 3.5.

FIG. 5 shows a schematic graph having plotted at its abscissa the relative distance between the natural frequencies δ and having plotted at its ordinate the Q factor. Curves 68₁ to 68₈ show different implementations of the sound transducer system with relative bandwidths between 15% (curve 68₁) and 50% (curve 68₈). FIG. 5 illustrates how decoupling of the resonance frequencies f₁/ω₁ and f₂/ω₂ facilitates the needed suppression of the Q factor for a relative bandwidth achieved. For example, if a relative bandwidth of 20% is desired in the context of an implementation (cf, e.g. curve 68₂), the Q factor may be adjusted up to a value of 3 if the natural frequencies of the transmission unit 12 and the receiver unit 18 are equal. However, it may even be approximately 3.6 if the relative distance between the resonance frequencies is 10%, i.e. f₂/f₁=1.1. In preferred embodiments, the relative bandwidth is at least 15%, at least 20%, or even more.

If the relative distance is 20% (6=0.20), a configuration of a Q factor of 3 even achieves a relative bandwidth of approximately 30% (curve 68₄). At this point, a higher Q factor would only increase the maximums or the peaks at the resonance frequencies, cf. FIG. 2, without decreasing the bandwidth, and lower Q factors would only increase the relative bandwidths.

FIG. 5 shows that using correspondingly large relative distances and low Q factors may achieve relative bandwidths of at least 35%, at least 40%, at least 45% or, up to 50% or more.

For example, when considering the relative distance δ=0.1, it can be seen that a low factor should be used for obtaining larger relative bandwidths (Br), in turn, fewer requirements with respect the relative bandwidth (curve 68₈ towards curve 68₁) may decrease the requirements with respect to the Q factor and higher values thereof may be admissible.

The ends of the curve 68₁ to 68₈ towards larger relative distances show a possible start of the underdamped state that may be influenced by the relative distance δ and the Q factor. Thus, at a relative distance of δ=0.3, a Q factor of approximately 1.5 may be used to still achieve a relative bandwidth of 50%, curve 68₆. If the Q factor is increased, the relative bandwidths obtained may decrease, curves 68₆ and 68₇. At a relative distance of δ=0.25.

In addition, FIG. 5 shows that the distance δ between natural frequencies may mitigate the requirements as to the suppression of the Q factor. Without decoupling, a Q factor of 3 may be adopted to achieve a relative bandwidth of 20%, for example. With δ=0.1, the requirement is at approximately Q=3.6, or a top limit of 3.5.

The curves can also be interpreted as follows: compared to a theoretical value at which the Q factor is reduced to a value of up to 2 without using the present knowledge, and wherein a Br of up to approximately 30% may be obtained, the present invention enables the use of a distance δ of approximately 0.22, so as to instead advantageously achieve a Br of approximately 40% with the same Q factor.

In other words, FIG. 5 shows a calculation of the Q factor needed to achieve certain relative bandwidths. The decoupling of the natural frequencies of the transmitter and the receiver (represented with δ=(ω₂−ω₁)/ω_{c})) enables a further degree of freedom in the design of the time-of-flight sensor. According to embodiments, a method for configuring an ultrasonic transducer system includes selecting a Q factor of the ultrasonic transducer system on the basis of the first natural frequency and the second natural frequency so that a desired relative bandwidth of the system is obtained by selecting a low Q factor on the one hand, and a high Q factor is obtained for obtaining a sensitivity on the other hand.

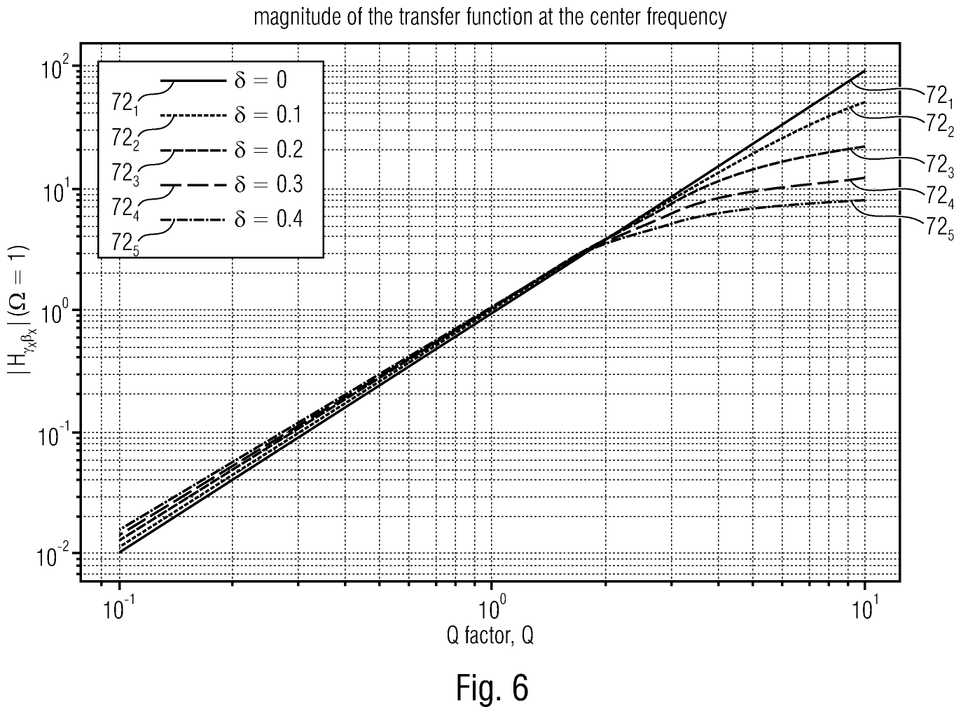

In the design, there may also be the tradeoff that smaller Q factors lead to a smaller contribution in the transfer function, as is described on the basis of FIG. 6, where a graph shows at its abscissa the Q factor and at its ordinate the absolute value of the entire transfer function H_{TxRx} for a value of 0=1. The absolute value of the transfer function is therefore illustrated at the center frequency ω_{c}. This is plotted for different curves 72₁ to 72₅ comparing a difference of the natural frequencies of 0 (matching natural frequencies), a deviation of 10%, 20%, 30%, or 40%. It is shown that Q factors of less than 2, in particular of less than 1, only add a small share to the transfer function.

With respect to FIG. 2 as well as FIG. 5 and FIG. 6, one can arrive at the following conclusion: the distance between natural frequencies f₁ and f₂ is smaller than the effective bandwidth of the arrangement, or of the bandpass, due to the superimposition of the transfer function. It may be derived from the diagram of FIG. 2 that, it the ratio between natural frequencies is at least 1.1, and the Q factor is up to 3,5, the partial bandwidth of at least 20% may be achieved.

In other words, FIG. 6 shows a graphic illustration of the dependence of the amplitude amplification on the Q factor for a transfer function shown in FIG. 2. If the resonance frequencies of the transmitter and the receiver are spaced apart further, i.e, the value δ increases, an increase of the Q factor leads only slightly to a larger amplitude amplification in the center frequency from a certain value onwards, contrary to the case in which both natural frequencies are equal. Thus, for example, FIG. 6 shows that the curves 72₁ to 72₅ approach each other with an increasing Q factor in the range Q=10⁻¹ to Q=10⁰.

Further aspects of the present disclosure are listed in the following:
1. An apparatus configured to generate and capture ultrasound in a gas, in particular air, may be provided, including:
   a. At least one transmission unit that, upon application of an oscillating voltage, may generate a pressure difference between its front and rear sides and whose resonance frequency is above the audible range for humans (20 kHz).
   b. At least one receiver unit capable to drain electrical charges from a voltage source upon detection of a pressure difference between its front and rear sides and whose resonance frequency is above that of the transmitter unit at least by the factor of 1.1.
   c. A driver unit capable to apply a voltage signal to at least one transmission unit so that the bandwidth of the signal covers the entire spectrum between the resonance frequency of the transmitter and that of the receiver unit.
   d. An amplifier unit connected to at least one sensor unit such that it generates a voltage that is directly proportional to the oscillating charge that this unit draws as a reaction to the pressure waves captured by it.
   e. A circuit board having mounted thereon at least the transmission and reception units and that preferably also has space for mounting the driver and amplifier units.
   f. Wherein the transmission unit is not strongly underdamped so that the amplitude of the pressure waves generated by it steadily increases with the frequency until reaching the resonance point, after which it transitions softly into a range with an approximately flat response behavior without a sharp resonance peak. Here, a Q factor of less than 3.5 is recommended.
   g. wherein the reception unit is not strongly underdamped so that the amplitude of the charge that it draws as a reaction to the pressure waves remains relatively unchanged with the frequency until reaching the resonance point, after which its reaction decreases without having a sharp resonance peak. Here, a Q factor of less than 3.5 is recommended.
   h. wherein the circuit board comprises openings for the airflow to the rear side of the transmission and reception units, i.e. to the side of the elements mounted on the circuit board. The use of a circuit board as a carrier substrate and for providing one or several openings is optional and may easily be substituted by other substrates or ways of fastening.
2. The apparatus described in (1), wherein a cavity is arranged on the circuit board such that it separates the air volume to which the front sides of the transmission and reception units are exposed from the air volume to which their rear sides are exposed.
3. The apparatus described in (1), wherein the transmission units and the reception units are mounted on separate circuit boards.
4. The apparatus described in (3), wherein a cavity is mounted on each board as described in (2).

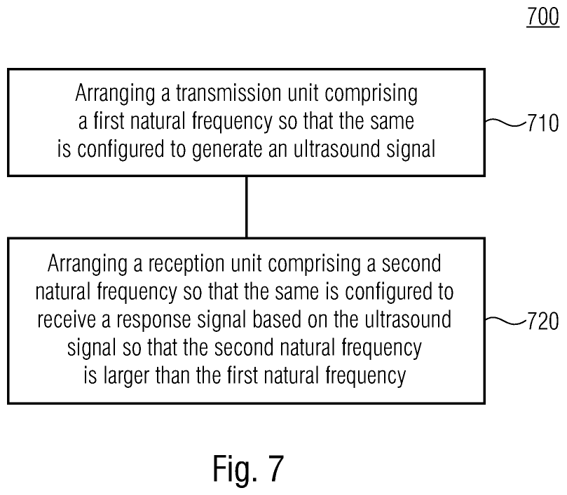

FIG. 7 shows a schematic flow diagram of a method 700 according to an embodiment. The method 700 may be used to manufacture an ultrasonic transducer system described herein. A step 710 includes arranging a transmission unit comprising a first natural frequency so that the same is configured to generate an ultrasonic signal. A step 720 includes arranging a reception unit comprising a second natural frequency so that the same is configured to receive a response signal based on the ultrasonic signal so that the second natural frequency is larger than the first natural frequency. Optionally, the step of selecting the Q factor may be used to carry out a selection of the transmission unit and/or the receiver unit.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### SOURCES

[1] Adelegan, O. J., Coutant, Z. A., Wu, X., Yamaner, F. Y., & Oralkan, Ō. (2021). Design and Fabrication of Wideband Air-Coupled Capacitive Micromachined Ultrasonic Transducers With Varying Width Annular-Ring and Spiral Cell Structures, IEEE Transactions on Ultrasonics, Ferroelectrics, and Frequency Control, 68(8), 2749-2759, https://doi.org/10.1109/TUFFC.2021.3076143
[2] Apte, N., Park, K. K., Nikoozadeh, A., & Khuri-Yakub. B. T. (2014). Bandwidth and Sensitivity Optimization in CMUTs for Airborne Applications, 2014 IEEE International Ultrasonics Symposium Proceedings, https://doi.org/10.1109/ULTSYM.2014.0042
[3] Bao, M. & Yang, H. (2007). Squeeze film air damping in MEMS, Sensors and Actuators A: Physical, 136(2007), 3-27, https://doi.org/10.1016fj.sna.2007.01.008
[4] Beranek, L. L. (1954). Acoustics. Cambridge, MA: Acoustical Society of America.
[5] Fiorillo, A. S., Pullano, S. A., Bianco, M. G., Critello, C. D. (2019) Bioinspired US sensor for broadband applications, Sensors and Actuators A: Physical, 294, pp. 148-153, https-J/doi.org/10.1016/j.sna.2019.05.019
[6] Hazas, M., & Hopper, A. (2006). Broadband Ultrasonic Location Systems for Improved Indoor Positioning, IEEE Transactions on Mobile Computing, 5(5), https-J/doi.org/10.1109/TMC.2006.57
[7] Klauder, J. R., Price, A. C., Darlington, S., & Albersheim, W. J. (1960). The Theory and Design of Chirp Radars, The Bell System Technical Journal, XXXIX(4)
[8] Ma, B., Firouzi, K., Brenner, K., & Khuri-Yakub, B. T. (2019). Wide Bandwidth and Low Driving Voltage Vented CMUTs for Airborne Applications, IEEE Transactions on Ultrasonics, Ferroelectrics, and Frequency Control, 66(11), 1777-1785, https://doi.org/10.1109/TUFFC.2019.2928170
[9] Misra, P., Kottege, N., Kusy, B., Ostry, D., & Jha, S. (2013). Acoustical Ranging Techniques in Embedded Wireless Sensor Networked Devices, ACM Transactions on Sensor Networks, 10(1), pp. 1-38, https-J/doi.org/10.1145/2529981
[10] Monsalve, J. M., Kircher, M., Wall, F., Krenkel, M., Kaiser, B., Langa, S., & Schenk, H. A. G. (2020). First Time of nanoscopic electrostatic drives pushing for ultrasonic transmission for gesture recognition, 2020 IEEE International Ultrasonics Symposium (IUS), https://doi.org/10.1109/IUS46767.2020.9251316
[11] Quazi, A. H. (1981). An Overview on the Time Delay Estimate in Active and Passive Systems for Target Localization, IEEE Transactions on Acoustics, Speech, and Signal Processing, ASSP-29(3)
[12] Weinstein, E., & Weiss, A. J. (1984). Fundamental Limitations in Passive Time-Delay Estimation-Part II: Wide-Band Systems, IEEE Transactions on Acoustics, Speech, and Signal Processing, 32(5), 1064-1078, https://doi.org/10.1109/TASSP.1984.1164429

1. Ultrasonic transducer system, comprising:
a transmission unit comprising a first natural frequency and configured to generate an ultrasonic signal;
a reception unit comprising a second natural frequency and configured to receive a response signal based on the ultrasonic signal;
wherein the second natural frequency is larger than the first natural frequency.

2. Ultrasonic transducer system according to claim 1, wherein the transmission unit and the reception unit form a bandpass that is at least partially characterized by the first natural frequency and the second natural frequency.

3. Ultrasonic transducer system according to claim 2, wherein the transmission unit contributes to the bandpass as a high-pass filter and the reception unit as a low-pass filter.

4. Ultrasonic transducer system according to claim 1, wherein the second natural frequency is larger than the first natural frequency at least by the factor 1.1.

5. Ultrasonic transducer system according to claim 1, wherein the transmission unit and/or the reception unit comprises a sound transducer comprising at least one of:
a capacitive micromachined sound transducer, cMUT;
a piezoelectric micromachined sound transducer, pMUT;
a polyvinylidene fluoride film.

6. Ultrasonic transducer system according to claim 1, comprising a driver unit coupled to the transmission unit and configured to apply to a transmission ultrasonic transducer of the transmission unit an electrical voltage that is proportional to a received excitation signal.

7. Ultrasonic transducer system according to claim 6, wherein the transmission ultrasonic transducer of the transmission unit is a capacitive transmission ultrasonic transducer and the driver unit is configured to apply an electrical bias voltage to the capacitive transmission ultrasonic transducer and to apply the electrical voltage with respect to the electrical bias voltage.

8. Ultrasonic transducer system according to claim 1, comprising an evaluation unit configured to evaluate the response signal on the basis of a pulse compression method.

9. Ultrasonic transducer system according to claim 1, configured for an operation of the transmission unit at a single transmission oscillation mode and/or configured for an operation of the reception unit at a single reception oscillation mode.

10. Ultrasonic transducer system according to claim 9, wherein the transmission unit comprises a plurality of sound transducers comprising matching natural frequencies within a tolerance range: and/or
wherein the reception unit comprises a plurality of sound transducers comprising matching natural frequencies within a tolerance range.

11. Ultrasonic transducer system according to claim 1, wherein the transmission unit is configured to emit the ultrasonic signal with a characteristic to acquire an amplitude of the reception signal at the location of the reception unit, comprising a local maximum within a tolerance range.

12. Ultrasonic transducer system according to claim 11, wherein the characteristic is based on at least one of the following:
a radiation property of the transmission unit;
a characteristic of a fluidic opening of a substrate of the transmission unit; and
an antenna structure for shaping the transmission signal.

13. Ultrasonic transducer system according to claim 1, comprising:
an amplifier unit coupled to a reception ultrasonic transducer of the reception unit and configured to acquire a transducer signal received by the reception ultrasonic transducer and to amplify the same so as to acquire an amplified signal that is approximately directionally proportional to a charge at the reception ultrasonic transducer;
an evaluation unit configured to evaluate the response signal on the basis of the amplified signal and a quantity based on the electrical charge of a reception ultrasonic transducer.

14. Ultrasonic transducer system according to claim 13, wherein the reception ultrasonic transducer is a capacitive reception ultrasonic transducer and the amplifier unit is configured to apply an electrical bias voltage to the capacitive reception ultrasonic transducer.

15. Ultrasonic transducer system according to claim 1, wherein the transmission unit comprises a horn antenna structure configured to influence a radiation direction of the ultrasonic signal.

16. Ultrasonic transducer system according to claim 1, wherein the reception unit comprises a horn antenna structure configured to influence a directional characteristic of the reception unit for receiving the response signal.

17. Ultrasonic transducer system according to claim 1, wherein the transmission unit is configured to output the ultrasonic signal into a gaseous medium; and/or
wherein the reception unit is configured to receive the reception signal from a gaseous medium.

18. Ultrasonic transducer system according to claim 1, wherein a relative bandwidth of the transmission unit and reception unit is at least 20%.

19. Ultrasonic transducer system according to claim 1, wherein an ultrasonic transducer of the transmission unit and an ultrasonic transducer of the reception unit are arranged on a substrate and are connected to a mutual medium via openings in the substrate

20. Ultrasonic transducer system according to claim 19, wherein the substrate comprises a printed circuit board.

21. Ultrasonic transducer system according to claim 1, wherein a structure of the transmission unit comprises a Q factor of up to 3.5 and/or wherein a structure of the reception unit comprises a Q factor of up to 3.5.

22. Ultrasonic transducer system according to claim 1, wherein a transmission ultrasonic transducer of the transmission unit is arranged in a volume, wherein the volume prevents an acoustic short circuit for the transmission ultrasonic transducer; and/or
wherein a reception ultrasonic transducer of the reception unit is arranged in a volume, wherein the volume prevents an acoustic short circuit for the reception ultrasonic transducer.

23. Ultrasonic transducer system according to claim 1, wherein a transmission ultrasonic transducer of the transmission unit is arranged on a first substrate; and a reception ultrasonic transducer of the reception unit is arranged on a different second substrate.

24. Ultrasonic transducer system according to claim 23, wherein the transmission ultrasonic transducer is arranged in a first volume to prevent an acoustic short circuit, and the reception ultrasonic transducer is arranged in a different second volume to prevent an acoustic short circuit.

25. Time-of-flight sensor with an ultrasonic transducer system according to claim 1.

26. Method for manufacturing an ultrasonic transducer system, comprising:
arranging a transmission unit comprising a first natural frequency so that the same is configured to generate an ultrasonic signal;
arranging a reception unit comprising a second natural frequency so that the same is configured to receive a response signal based on the ultrasonic signal;
so that the second natural frequency is larger than the first natural frequency.

27. Method according to claim 26, further comprising configuring the ultrasonic transducer system, comprising:
selecting a Q factor of the ultrasonic transducer system on the basis of the first natural frequency and the second natural frequency so that, on the one hand, a desired partial bandwidth of the system is acquired by selecting a low Q factor, and, on the other hand, a high Q factor is acquired for acquiring a sensitivity.
